(19) United States
(12) Patent Application Publication
(10) Pub. No.: US 2010/0241875 A1
(43) Pub. Date: Sep. 23, 2010

(54) EXTERNAL STORAGE DEVICE AND METHOD OF CONTROLLING THE SAME

(75) Inventors: Suguru ISHII, Nagoya-shi (JP); Takuya SAITO, Nagoya-shi (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/726,258

(22) Filed: Mar. 17, 2010

(30) Foreign Application Priority Data
Mar. 18, 2009 (JP) 2009-66706

(51) Int. Cl. G06F 12/14

(52) U.S. Cl. 713/193; 711/163; 726/24; 711/E12.091; 711/E12.092

(57) ABSTRACT

The external storage device has a read-only section and a read/write enabled section in a storage section. In the read-only section there is stored an antivirus software detection program adapted to detect the presence of antivirus software installed on a host computer. When the external storage device is connected to the host computer, the antivirus software detection program will be executed automatically by the host computer. When a storage section access controller provided to the external storage device receives from the antivirus software detection program a notification that the presence of antivirus software has been detected, it will allow writing to the read/write enabled section.

### CROSS-REFERENCE TO RELATED APPLICATIONS

The present application claims the priority based on Japanese Patent Application No. 2009-66706 filed on Mar. 18, 2009, the disclosure of which is hereby incorporated by reference in its entirety.

### BACKGROUND OF THE INVENTION

1. Field of the Invention

This invention relates to an external storage device adapted for detachable connection to a computer.

2. Description of the Related Art

There are some external storage devices, such as USB flash disks and hard disk drives, which are designed to connect to a host computer utilizing a connection interface such as USB that supports hot plugging. If such an external storage device happens to be connected to a host computer that has been infected with a computer virus, there is a possibility that the external storage device may become infected with the computer virus upon receiving writing of data. To date, a number of techniques have been proposed for protecting an external storage device against infection by a computer virus (e.g. JP 2008-186052 A).

However, damage caused by computer virus infections of external storage devices is on the increase, and sufficient measures to protect external storage devices from computer virus infections have yet to be developed.

### SUMMARY OF THE INVENTION

An object of this invention is to provide a technique for protecting an external storage device connected to a computer from becoming infected with a computer virus.

A first aspect of this invention is directed to an external storage device adapted for detachable connection to a computer. The external storage device includes a connection interface device for connection to the computer; a first storage section for which only reading of stored data is enabled; a second storage section for which writing of data is enabled; an access controller for controlling access to the first and second storage sections by the computer via the connection interface device; and an antivirus software detection program stored in the first storage section and adapted to detect presence of antivirus software installed on the computer. Upon connection of the external storage device to a computer, the antivirus software detection program runs automatically and is executed by the computer. The access controller executes a write permission control where the access controller prohibits writing of data from the computer to the second storage section until receiving from the antivirus software detection program a notification that presence of antivirus software was detected, and permits writing of data from the computer to the second storage section after receiving notification that presence of antivirus software has been detected. According to this aspect of the external storage device, writing of data will be permitted only after having detected the presence of antivirus software installed on the computer to which the unit is connected, and having verified security of the computer against computer viruses. Consequently, it will be possible to limit the likelihood of infection of the external storage device with a computer virus resulting from connection to a computer with low security against computer viruses; and to protect the external storage device against infection by a computer virus.

A second aspect of this invention is the external storage device according to the first aspect, wherein the connection interface device causes the computer to recognize the first and the second storage sections as respectively different logical devices. According to this aspect of the external storage device, the first and second storage sections will be recognized as different logical devices by the computer to which the unit is connected, thereby facilitating access control to the first and second storage sections.

A third aspect of this invention is the external storage device according to the first or second aspect, wherein the external storage device further includes a changeover switch for changing over control by the access controller. The access controller: (i) causes the computer to run the antivirus software detection program when the changeover switch has been set to a first setting, and executes the write permission control; and (ii) does not cause the computer to execute the antivirus software detection program when the changeover switch has been set to a second setting, and permits writing to the second storage section. According to this aspect of the external storage device, by means of a changeover switch, the user may optionally enable or disable the protective function against computer virus infection. Consequently, usability will be enhanced while at the same time enhancing security of the external storage device against computer viruses.

A fourth aspect of this invention is the external storage device according to any one of the first through third aspects, wherein the external storage device further includes an encryption process module adapted to execute an encryption process that includes encryption of write data to be written to the second storage section and decryption of read data from the second storage section. In response to the notification that the presence of antivirus software has been detected, the access controller causes the encryption process module to initiate authentication for the encryption process as a process of the write permission control. According to this aspect of the external storage device, because write data destined for the second storage section has been encoded by an encryption process module, security of the external storage device will be enhanced.

A fifth aspect of this invention is directed to a method of controlling writing of data to an external storage device connected to a computer. The method includes the steps of: (a) upon connection of the external storage device to a computer, causing the computer to execute an antivirus software detection program that has been stored in the external storage device, to thereby detect presence of antivirus software installed on the computer; and (b) permitting writing of data from the computer to the external storage device when the antivirus software detection program has detected presence of antivirus software. According to this aspect of the method, writing of data will be enabled only after the external storage device has verified security against computer viruses by the computer to which it is connected. Consequently, it will be possible to limit the likelihood of infection of the external storage device with a computer virus resulting from connection to a computer with low security against computer viruses; and to protect the external storage device against infection by a computer virus.

A sixth aspect of this invention is directed to an external storage device adapted for detachable connection to a computer. The external storage device includes: a connection interface device for connection to the computer; a first storage section for which only reading of stored data is enabled; a second storage section for which writing of data is enabled; an access controller for controlling access to the first and second storage sections by the computer via the connection interface device; an antivirus software detection program stored in the first storage section and adapted to detect presence of antivirus software installed on the computer; and an embedded antivirus program stored in the first storage section and adapted to monitor the second storage section for computer virus infections. Upon connection of the external storage device to a computer, the antivirus software detection program runs automatically and is executed by the computer. If the antivirus software detection program has not detected presence of antivirus software on the computer, the embedded antivirus program runs and is executed by the computer. According to this aspect of the external storage device, even if antivirus software is not detected on the computer to which the external storage device is connected, by running the embedded antivirus program it will be possible to avoid infection by a computer virus. Consequently, it will be possible to limit the likelihood of the external storage device becoming infected with a computer virus resulting from connection to a computer with low security against computer viruses, and to protect the external storage device against infection by a computer virus.

A seventh aspect of this invention is the external storage device according to the sixth aspect, wherein the connection interface device causes the computer to recognize the first and the second storage sections as respectively different logical devices. According to this aspect of the external storage device, the first and second storage sections will be recognized as different logical devices by the computer to which the device is connected, thereby facilitating access control to the first and second storage sections.

A eighth aspect of this invention is the external storage device according to the sixth or seventh aspect, wherein the external storage device further includes an encryption process module adapted to execute an encryption process that includes encryption of write data to be written to the second storage section and decryption of read data from the second storage section. According to this aspect of the external storage device, because write data destined for the second storage section has been encoded by a encryption process module, security of the external storage device will be enhanced.

A ninth aspect of this invention is directed to a method of controlling writing of data to an external storage device connected to a computer. The method includes the steps of: (a) upon connection of the external storage device to a computer, causing the computer to execute an antivirus software detection program that has been stored in the external storage device, to thereby detect presence of antivirus software installed on the computer; and (b) if the antivirus software detection program has not detected presence of antivirus software, causing the computer to execute an embedded antivirus program that is preliminarily stored in the external storage device and adapted to monitor the external storage device for computer virus infections. According to this aspect of the method, even if antivirus software is not detected on the computer to which the external storage device is connected, an embedded antivirus program will be run by the computer. Consequently, it will be possible to limit the likelihood of the external storage device becoming infected with a computer virus.

This invention may be embodied in various forms, for example, an external storage device and a method of controlling a external storage device; a computer program for realizing the functions of such devices or a control method; or a recording medium having such a computer program recorded thereon.

These and other objects, features, aspects, and advantages of this invention will become more apparent from the following detailed description of the preferred embodiments with the accompanying drawings.

### BRIEF DESCRIPTION OF THE DRAWINGS

FIG. 1 is a block diagram depicting the internal configuration of an external storage device and a host computer in Embodiment 1;

FIG. 2 is a flowchart depicting a control procedure when the external storage device and the host computer in Embodiment 1 have been connected;

FIGS. 3A and 3B illustrate process content of Steps S40 to S60 in Embodiment 1;

FIG. 4 is a block diagram depicting the internal configuration of an external storage device and a host computer in Embodiment 2;

FIG. 5 is a flowchart depicting the control procedure when the external storage device and the host computer in Embodiment 2 have been connected;

FIGS. 6A and 6B illustrate process content of Steps S40 to S60 in Embodiment 2;

FIG. 7 is a block diagram depicting the internal configuration of an external storage device and a host computer in Embodiment 3;

FIG. 8 is a flowchart depicting a control procedure when the external storage device and the host computer in Embodiment 3 have been connected; and

FIGS. 9A and 9B illustrate a process of enabling a write operation to the external storage device by the host computer in Embodiment 3.

### DESCRIPTION OF THE PREFERRED EMBODIMENT

Preferred embodiments of this invention will be described below in the following order.

A. Embodiment 1:

B. Embodiment 2:

C. Embodiment 3:

D. Modified Embodiments:

### A. Embodiment 1

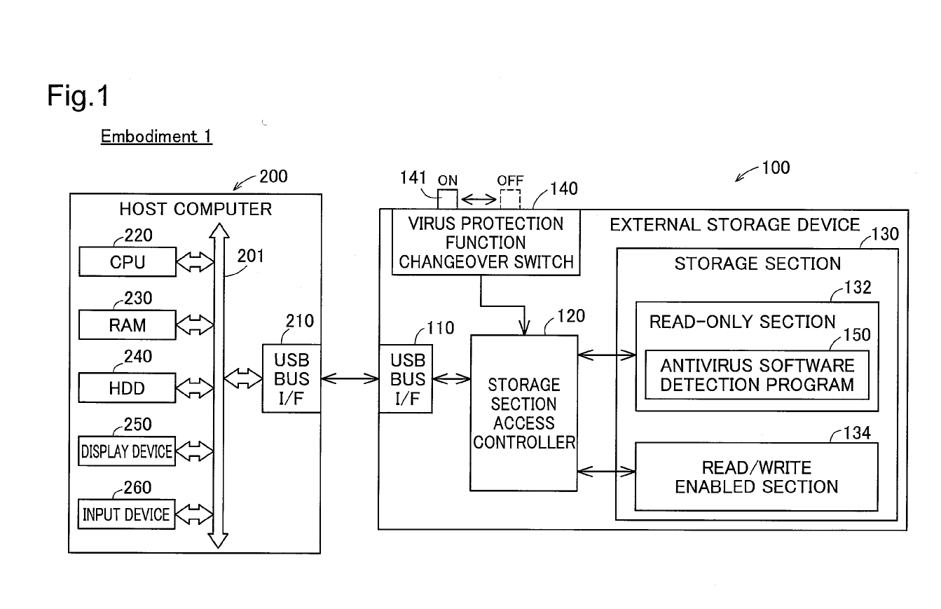

FIG. 1 is a block diagram depicting the internal configuration of an external storage device according to Embodiment 1 of this invention, and a host computer connected to the external storage device. This external storage device 100 is a storage device adapted for detachable connection to a host computer 200 utilizing a USB (Universal Serial Bus) connection interface. The external storage device 100 may be constituted by a USB flash disk, SSD (solid state disk), or hard disk drive for example. The external storage device 100 is furnished with a USB interface 110, a storage section access controller 120, a storage section 130, and a computer virus protection function changeover switch 140.

The storage section access controller 120 is constituted as a small microcomputer furnished with CPU, RAM and ROM, and is adapted to control access to the storage section 130 by the host computer 200 via the USB interface 110. The storage section access controller 120 also carries out communication for the purpose of performing various settings and carrying out control in relation to the USB connection between the external storage device 100 and the host computer 200.

The storage section 130 is composed of rewriteable nonvolatile storage such as a flash storage or a magnetic disk. The storage section 130 has a read-only section 132 and a read/write-enabled section 134 provided as pre-established storage sections. The read-only section 132 is a storage section for preliminarily storing data and programs which will be used in control of the external storage device 100, and is write-prohibited for user-input data. In the read-only section 132, an antivirus software detection program 150 has been stored by way of a program that is executed automatically (autorun program). The functions of the antivirus software detection program 150 will be discussed later. The read/write enabled section 134 is a storage section that is read-enabled and write-enabled for user-input data. Specific access control of the read-only section 132 and the read/write enabled section 134 by the storage section access controller 120 will be discussed later.

The computer virus protection function changeover switch 140 has a moveable slider 141 arranged exposed to the outside of the housing of the external storage device 100, and can be switched between the ON state (first state) or the OFF state (second state) depending on the position of the slider 141. The storage section access controller 120 will detect the switch state of the computer virus protection function changeover switch 140, and will change over control thereof according to the detected switch state. The specifics of control changeover will be discussed later.

The host computer 200 includes a USB bus interface 210, CPU 220, RAM 230, a hard disk drive (HDD) 240, a display device 250, and an input device 260. These constituent portions are interconnected by an internal bus 201.

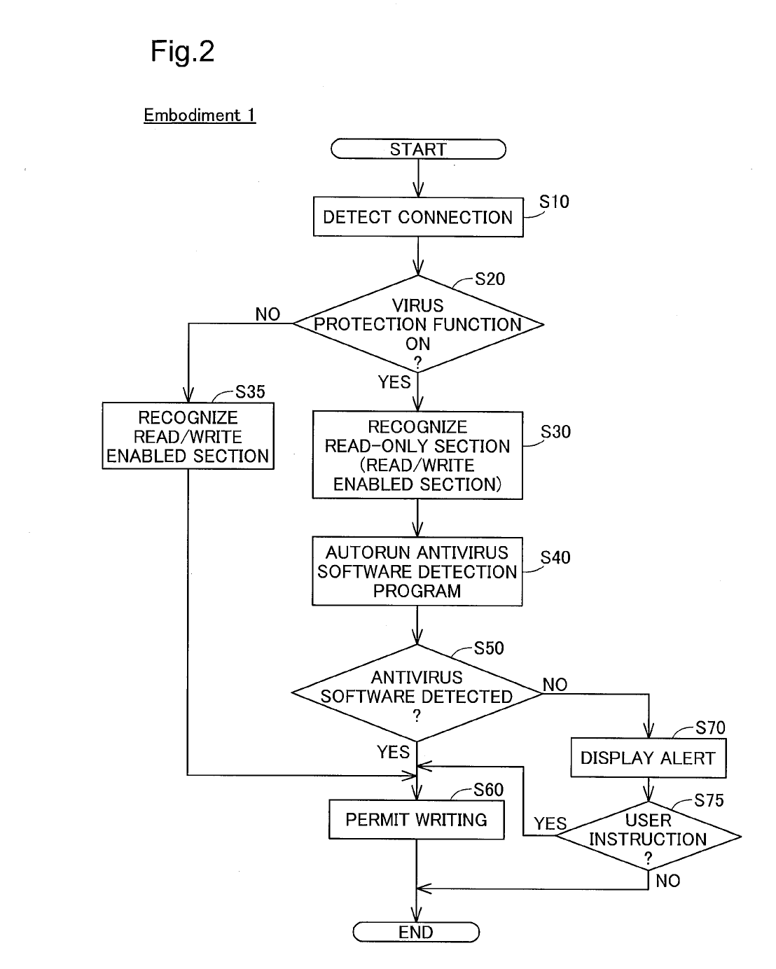

FIG. 2 is a flowchart depicting the procedure of a control process that takes place when the external storage device 100 is connected to the host computer 200. When the external storage device 100 is connected to the host computer 200, the USB bus interface 210 of the host computer 200 will electrically detect the device connection (Step S10).

Ordinarily, when a host computer detects connection of a USB compliant device, an initialization process according to the USB protocol will be carried out between the device and the host computer. As a specific example, processes such as exchange of a USB device request, exchange of descriptors (e.g. Device Class and Vendor ID or Product ID), and allocation of an address to the connected device may be carried out. In the initialization process, upon recognizing the connected device, the host computer will establish the device class of the connected device. The host computer will then run an appropriate device driver for the established device class. Ordinarily, the device class will be set to “mass storage class” for storage devices.

In the external storage device 100 of this embodiment, the storage section access controller 120 will detect the switch status of the computer virus protection function changeover switch 140 prior to the initialization process (Step S20). Then, if the computer virus protection function changeover switch 140 is in the ON state, the storage section access controller 120 will execute the process of Steps S30 to S50. Specifically, in Step S30, the storage section access controller 120 will prompt the host computer 200 to recognize the read-only section 132 and the read/write enabled section 134 of the storage section 130 as different logical mass storage devices in the initialization process. More specifically, the read-only section 132 will be recognized as a storage device from which data can only be read (similar to a CD-ROM drive with media installed). Meanwhile, the read/write enabled section 134 will be recognized as a storage device for which reading and writing of data is enabled (similar to a hard disk drive).

The USB protocol defines the functions termed Multiple LUN (Multiple Logical Unit Number) and Composite Device. Using these functions, when a single USB device has been connected in the above manner, it will be possible to prompt the host computer to logically recognize it as though it were USB devices having multiple different functions.

The storage section access controller 120 is designed such that even if it receives from the host computer 200 a request to write data to the read/write enabled section 134 in this Step S30, the request will be ignored or discarded. Alternatively, the storage section access controller 120 may cause the host computer 200 to recognize the read-only section 132 only at the point in time of Step S30.

In Step S40, the antivirus software detection program 150 that has been stored in the read-only section 132 will be executed automatically (auto run) on the host computer 200. The antivirus software detection program 150 is a program for detecting whether antivirus software has been installed on the host computer to which the external storage device 100 has been connected. Specifically, executable file names and registry information for typical antivirus software have been registered in the antivirus software detection program 150. The antivirus software detection program 150 will search the hard disk drive 240 of the host computer 200 to ascertain whether an antivirus software executable file and registry information are present. Alternatively, where the host computer 200 is running the Windows™ OS, the antivirus software detection program 150 may search character string information that is displayed in the Security Center of the Control Panel, to detect whether antivirus software is installed.

The antivirus software detection program 150 will then notify the storage section access controller 120 of the detection result. If the presence of antivirus software on the host computer 200 has been detected (Step S50: YES), the storage section access controller 120 will enable writing of data to the read/write enabled section 134 by the host computer 200 (Step S60). It will therefore be possible for the host computer 200 to utilize the read/write enabled section 134 as a write-enabled storage device.

If only the read-only section 132 has been recognized by the host computer 200 in Step S30, the storage section access controller 120 may perform a bus reset of the USB bus interface 110 in Step S60, and then prompt the host computer 200 to recognize the read/write enabled section 134 in the initialization process subsequent to the bus reset.

If the antivirus software detection program 150 was not able to detect antivirus software (Step S50: NO), the user will be alerted of this fact via the display device 250 (FIG. 1) of the host computer 200 (Step S70). The antivirus software detection program 150 will then receive a user instruction via the input device 260 of the host computer 200 (Step S75). If the user has instructed for writing of data to be allowed anyway (Step S75: YES), the storage section access controller 120 will enable writing of data to the read/write enabled section 134 (Step S60). If on the other hand the user has not instructed for writing of data to be allowed (Step S75: NO), write operations to the external storage device 100 will continue to be restricted.

In Step S20, in the event it is detected that the computer virus protection function changeover switch 140 is in the OFF state (Step S20: NO), the storage section access controller 120 will prompt the host computer 200 to recognize the read/write enabled section 134 only in the initialization process (Step S35). That is, in this case the read-only section 132 will not be recognized by the host computer 200. Then, the storage section access controller 120, without first verifying security of the host computer 200 against computer viruses, will allow writing of data to the read/write enabled section 134 by the host computer 200 (Step S60). That is, if the computer virus protection function changeover switch 140 is in the OFF state, the external storage device 100 will function like an ordinary storage device lacking any protection functionality against computer virus infections.

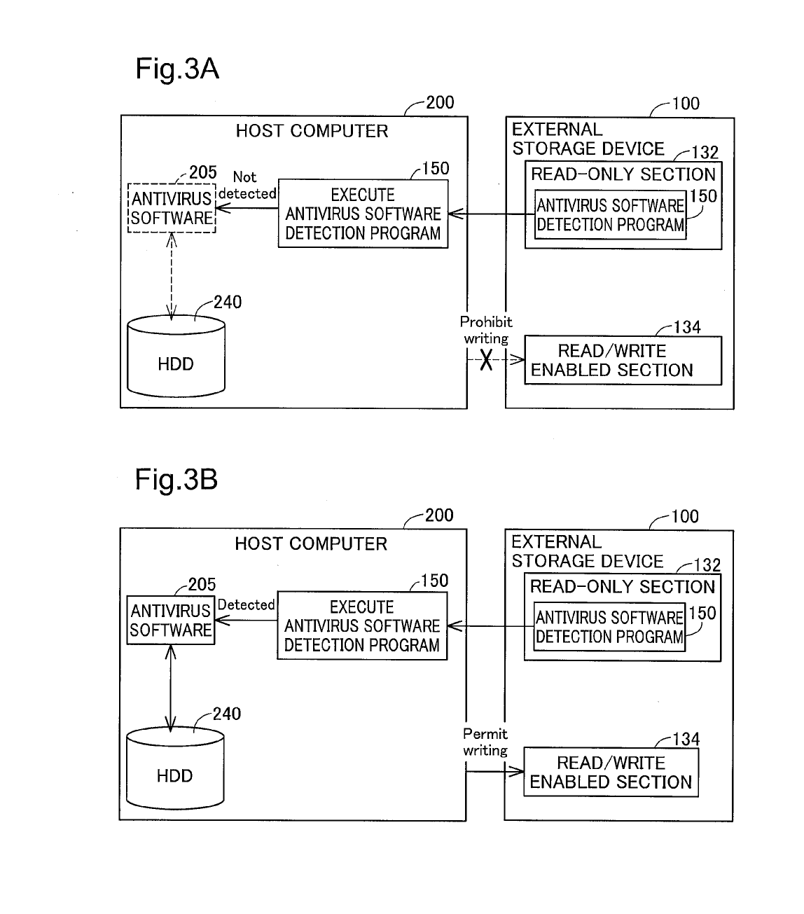

FIGS. 3A and 3B illustrate the process of Steps S40 to S60 described above. FIG. 3A depicts a condition in which the antivirus software detection program 150 has been automatically executed from the read-only section 132 by the host computer 200, and antivirus software 205 is not detected. In FIG. 3A, the fact that write operations cannot take place from the host computer 200 to the read/write enabled section 134 of the external storage device 100 is denoted by a broken line arrow with a mark “X”. FIG. 3B depicts a condition in which the antivirus software detection program 150 has detected antivirus software 205, and writing to the read/write enabled section 134 by the host computer 200 is permitted.

Thus, once the antivirus software 205 in the host computer 200 has been detected, writing of data will be enabled in the external storage device 100. On the other hand, if antivirus software 205 has not been installed on the host computer 200 and the antivirus software detection program 150 has not detected antivirus software 205, there is a high probability that the host computer 200 is infected with a computer virus. Therefore, writing of data to the external storage device 100 by the host computer 200 will not be permitted. That is, this external storage device 100 will permit writing of data only after verification of security against computer viruses by the connected host computer, thereby preventing infection with a computer virus from a host computer with low security.

Thus, according to the external storage device 100 of this embodiment, writing of data will be restricted in cases where the device has been connected to a host computer with low security. Consequently, the external storage device 100 will be protected from with a computer virus via the host computer.

### B. Embodiment 2

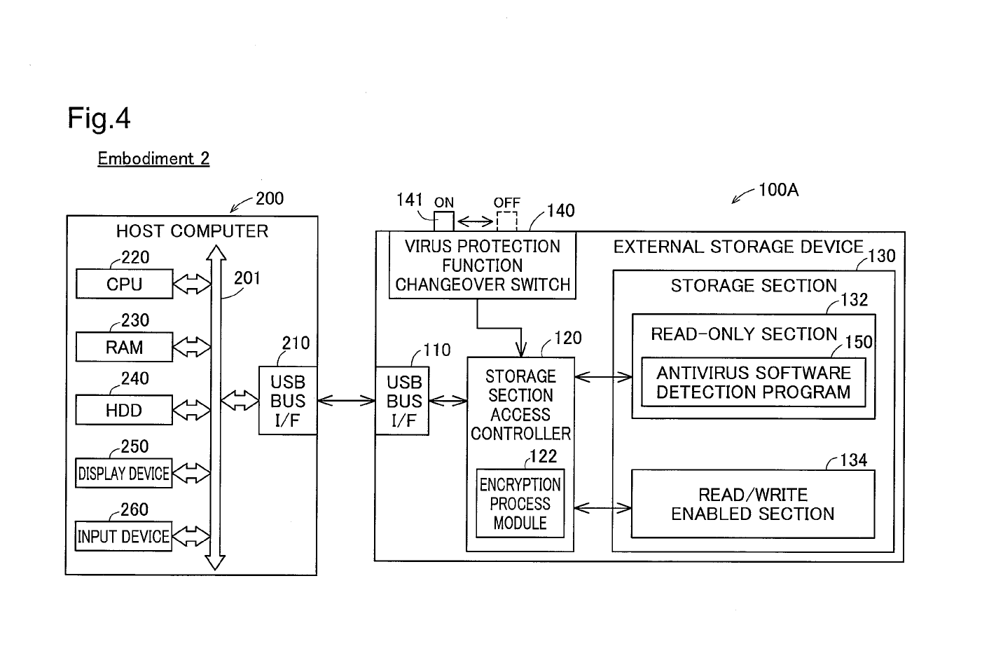

FIG. 4 is a block diagram depicting the internal configuration of an external storage device according to Embodiment 2 of this invention. FIG. 4 is substantially identical to FIG. 1, apart from the storage section access controller 122 of the external storage device 100A having a encryption process module 122. The encryption process module 122 is a hardware circuit intended to enhance security of the external storage device 100A, and has been designed to execute an encryption process that includes encryption of data written to the read/write enabled section 134 and decryption of data read from the read/write enabled section 134. The encryption process module 122 may be constituted as a hardware circuit or a software, i.e. an encryption process program stored in the read-only section 132.

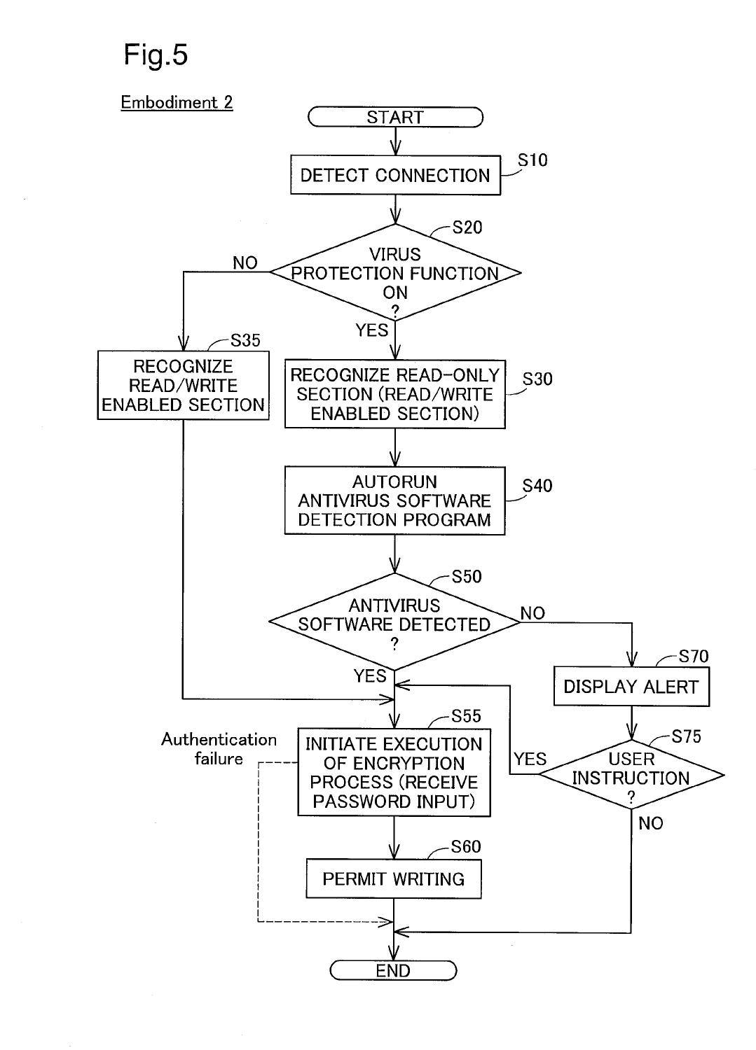

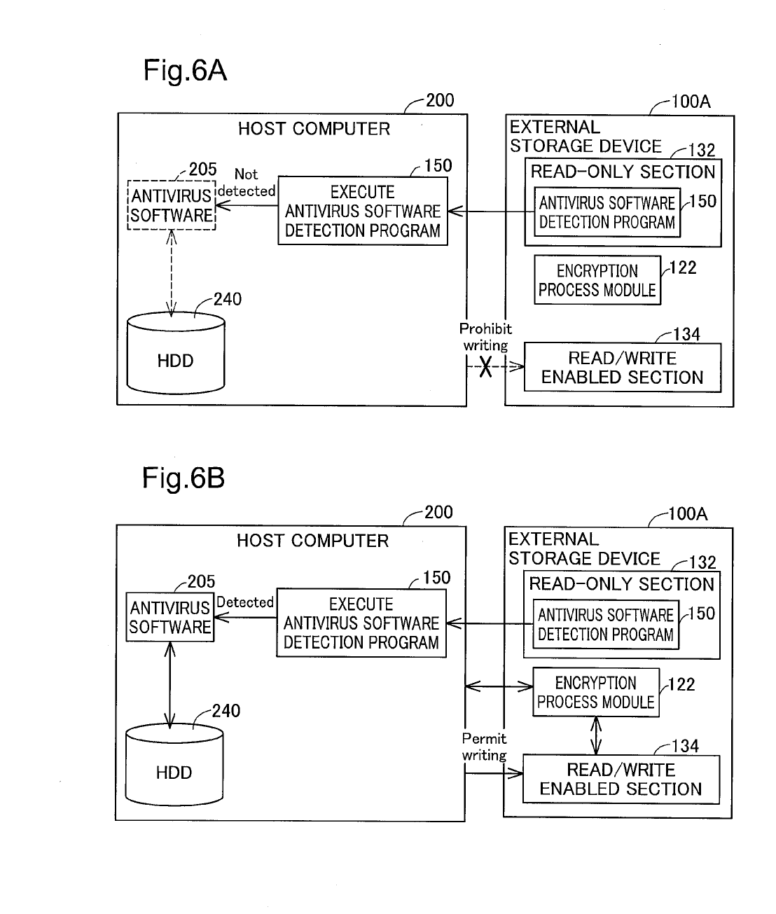

FIG. 5 is a flowchart depicting the control procedure when the external storage device 100A has been connected to the host computer 200. FIG. 5 is the same as FIG. 2 apart from the addition of Step S55. FIGS. 6A and 6B illustrate the process of Steps S40 to S60. FIG. 6A is substantially identical to FIG. 3A, apart from the addition of the encryption process module 122 to the external storage device 100A. FIG. 6B is substantially identical to FIG. 3B, apart from depicting a condition in which the encryption process module 122 is running in the external storage device 100.

With the external storage device 100A of Embodiment 2, authentication for the encryption process will be initiated by the encryption process module 122 in response to detection of antivirus software 205 (Step S55). Specifically, via the display device 250 (FIG. 4) of the host computer 200, the encryption process module 122 will prompt the user to enter a password and will carry out user authentication through a password entered from the input device 260. If the authentication is successful, the storage section access controller 120 will be notified to this effect, and the storage section access controller 120 will notify the host computer 200 that writing of data to the read/write enabled section 134 is permitted. Write data from the host computer 200, upon being encrypted by the encryption process module 122, will be written to the read/write enabled section 134. If the user authentication fails in Step S55, writing to the read/write enabled section 134 will remain prohibited. Reading of data from the read/write enabled section 134 will be possible even in this case however.

In Step S20, if it is detected that the computer virus protection function changeover switch 140 is in the OFF state, upon initiation of execution of the encryption process by the encryption process module 122 in Step S55, write operations to the read/write enabled section 134 will be permitted in Step S60. This will likewise take place if the user has instructed writing to the read/write enabled section 134 in Step S75.

According to the external storage device 100A of Embodiment 2, prior to enabling writing of data, verification of security of the host computer 200 against computer viruses and an encryption process during writing/reading of data will be carried out. Consequently, security of the external storage device 100 will be assured.

### C. Embodiment 3

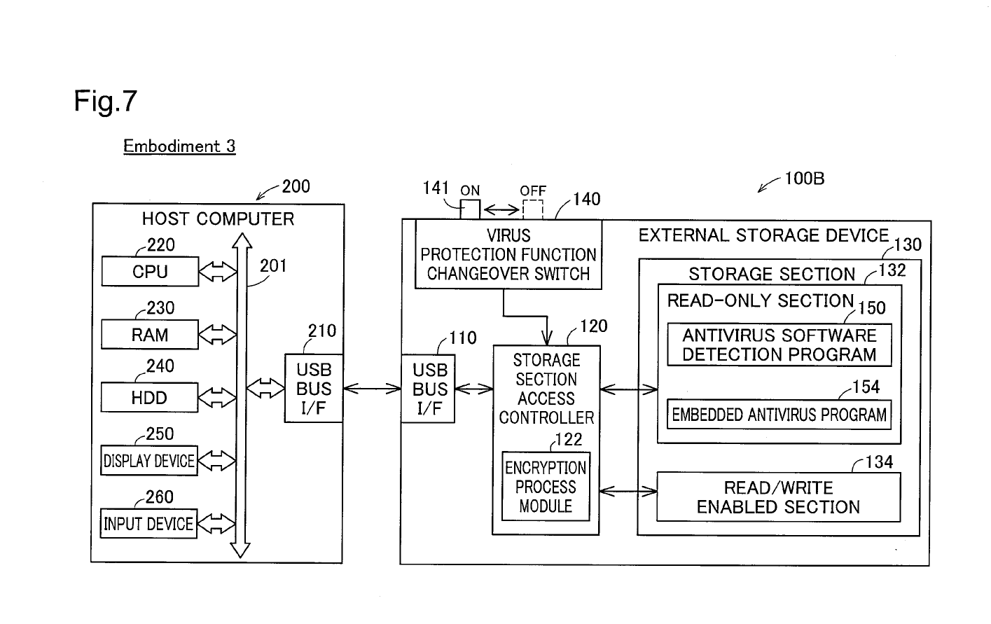

FIG. 7 is a block diagram depicting the internal configuration of an external storage device according to Embodiment 3 of this invention. FIG. 7 is identical to FIG. 4, except that an embedded antivirus program 154 has been stored in the read-only section 132 of the external storage device 100B. The embedded antivirus program 154 is a program for monitoring write data to be written into the read/write enabled section 134 in order to detect any computer viruses.

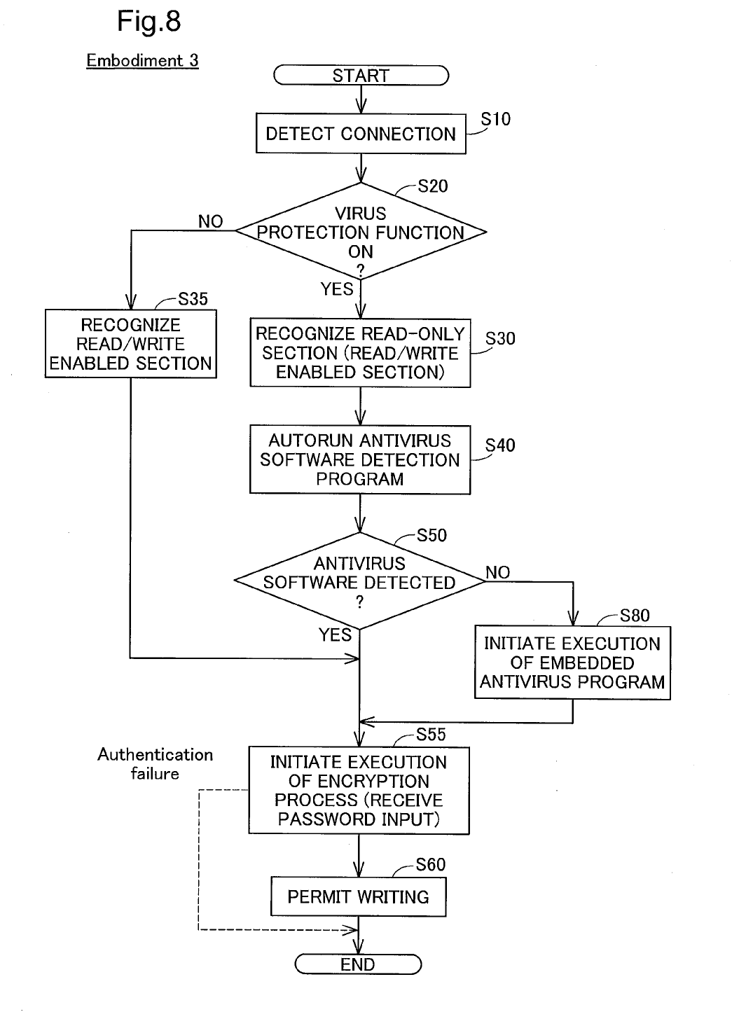

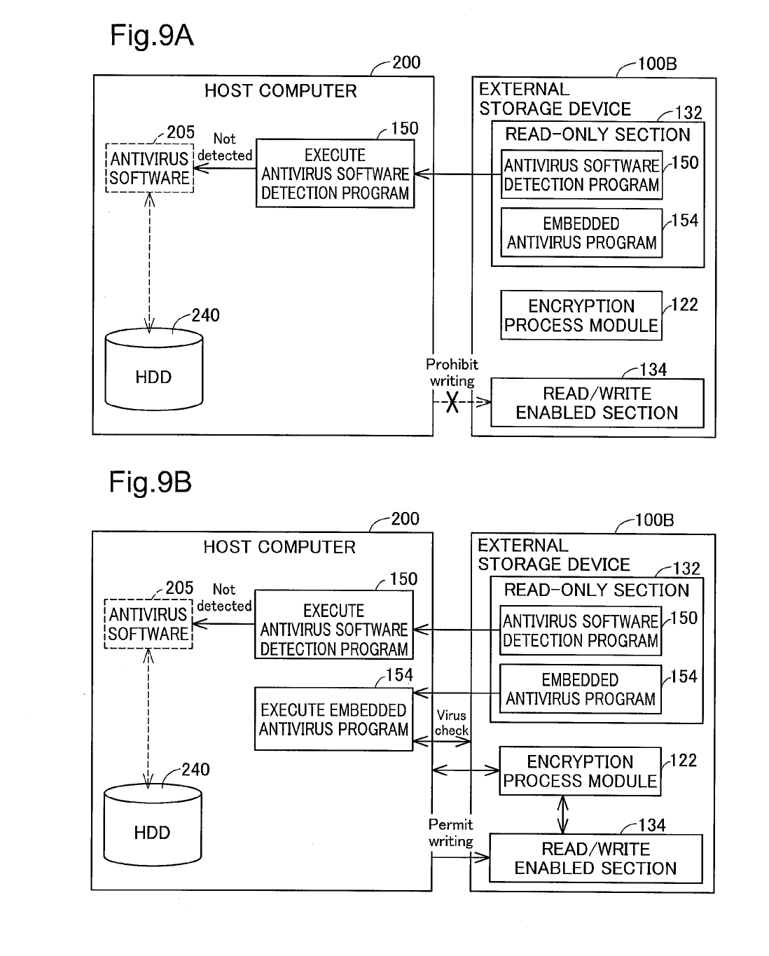

FIG. 8 is a flowchart depicting the procedure of the control process when the external storage device 100B has been connected to a host computer 200. FIG. 8 is identical to FIG. 5, except that Steps S70 and S75 have been replaced by Step S80. FIGS. 9A and 9B illustrate a process that takes place in Step S80, whereby the host computer 200 will be allowed to write to the external storage device 100B. FIG. 9A is identical to FIG. 6A except that the embedded antivirus program 154 has been added in the read-only section 132 of the external storage device 100B. FIG. 9B is identical to FIG. 6B except that it illustrates a condition in which antivirus software 205 has not been detected, and the embedded antivirus program 154 is being executed in the host computer 200.

With this external storage device 100B, if antivirus software 205 has not been detected in the host computer 200 in Step S50, execution of the embedded antivirus program 154 will be initiated in Step S80. Specifically, upon initiation of the embedded antivirus program 154 on the host computer 200, writing of data to the read/write enabled section 134 will be permitted in Steps S55 and S60. During writing of data to the read/write enabled section 134, the embedded antivirus program 154 will monitor the write data before it has been encrypted by the encryption process module 122, and will detect any computer viruses. The embedded antivirus program 154 may also be configured to check data that has been written to the read/write enabled section 134, in order to detect any computer viruses.

In this way, in the external storage device 100B of Embodiment 3, if antivirus software 205 has not been detected in the host computer 200, computer virus countermeasures will be carried out in the external storage device 100B by the embedded antivirus program 154. Consequently, the external storage device 100B will be protected from infection with computer viruses resulting from connection to a host computer with low security against computer viruses. If antivirus software 205 has been installed on the host computer 200, the embedded antivirus program 154 will not be executed. Thus, redundant execution of both the antivirus software 205 of the host computer 200 and the embedded antivirus program 154 in the host computer 200 can be avoided. Consequently, the efficiency of use of hardware resources in the host computer 200 will be improved.

### D. Modified Embodiments

This invention is not limited to the specific modes and embodiments set forth hereinabove, and while residing within the scope and spirit thereof may be reduced to practice in various other forms, such as the following modifications for example.

### D1. Modified Embodiment 1

In the preceding embodiments, some of the features realized through hardware may be replaced by software, and conversely some of the features realized through software may be replaced by hardware. For example, some of the functions of the storage section access controller 120 may be carried out by a program stored in the read-only section 132.

### D2. Modified Embodiment 2

In the preceding embodiments, the external storage device 100, 100A, 100B is connected to the host computer 200 by a USB connection. However, the connection interface of the external storage device 100, 100A, 100B and the host computer 200 need not be a USB connection. In preferred practice, the connection interface may be one that, when a single device has been connected to the host computer, will enable the host computer to recognize it as a plurality of logical devices.

However, the connection interface need not necessarily be a connection interface that enables the host computer to recognize a plurality of logical devices as described above. In this case, in the storage section access controller 120 of the external storage device, control may be carried out in the following manner for example. Specifically, when the external storage device is connected to the host computer 200, the storage section access controller 120 prompts the host computer 200 to recognize only the read-only section 132 as a connected device. Then, when the antivirus software 205 has been detected by the antivirus software detection program 150, the storage section access controller 120 performs a bus reset and prompts the host computer 200 to recognize only the read/write enabled section 134 as a connected device. With this feature as well, it will be possible to protect the external storage device from infection with a computer virus via the host computer 200.

### D3. Modified Embodiment 3

In the preceding embodiments, the antivirus software detection program 150 is used exclusively to detect whether antivirus software 205 is present on the host computer 200. However, the antivirus software detection program 150 may be configured not only to detect the presence of antivirus software 205, but also to verify its effectiveness. As a specific example, after the antivirus software detection program 150 has detected the presence of antivirus software 205, it may then compare the date that the pattern files of the antivirus software 205 were most recently updated with the date of the current detection process. Then, if the date of the update is significantly older than the detection process date (e.g. older by a month or more), the antivirus software detection program 150 may determine that the antivirus software 205 has low effectiveness. In such a case, the storage section access controller 120 may deem the host computer 200 to have low security against computer viruses, and not allow data to be written to the read/write enabled section 134. Also, the user may be alerted via the display device 250 of the host computer 200.

### D4. Modified Embodiment 4

In the preceding embodiments, the computer virus protection function changeover switch 140 is switchable between the ON state (first setting) and the OFF state (second setting) through hardware, i.e. the position of the slider 141. However, the computer virus protection function changeover switch 140 may instead be realized through software. Specifically, the status, i.e. the ON state or the OFF state, of the computer virus protection function changeover switch 140 may be set by the user through the agency of a program. Alternatively, the computer virus protection function changeover switch 140 may be omitted entirely.

### D5. Modified Embodiment 5

The antivirus software detection program 150 may be configured to have the capability to update the data used for detecting antivirus software. Specifically, in the event that considerable time has passed since the date of the most recent update of the data used for detecting antivirus software, the antivirus software detection program 150 may notify the user to this effect, and prompt the user to perform a data update process. Alternatively, the antivirus software detection program 150 may be configured to automatically update the data used for detecting antivirus software when the host computer 200 is connected to the Internet.

### D6. Modified Embodiment 6

In the preceding Embodiment 3, the host computer 200 may be prompted to recognize the read-only section 132 and execute the embedded antivirus program 154, even if the computer virus protection function changeover switch 140 is in the OFF state. Also, the encryption process module 122 in Embodiment 3 may be omitted.

What is claimed is:

1. An external storage device adapted for detachable connection to a computer, comprising:
a connection interface device for connection to the computer;
a first storage section for which only reading of stored data is enabled;
a second storage section for which writing of data is enabled;
an access controller for controlling access to the first and second storage sections by the computer via the connection interface device; and
an antivirus software detection program stored in the first storage section and adapted to detect presence of antivirus software installed on the computer,
wherein, upon connection of the external storage device to a computer, the antivirus software detection program runs automatically and is executed by the computer, and
the access controller executes a write permission control where the access controller prohibits writing of data from the computer to the second storage section until receiving from the antivirus software detection program a notification that presence of antivirus software was detected, and permits writing of data from the computer to the second storage section after receiving notification that presence of antivirus software has been detected.

2. The external storage device according to claim 1, wherein
the connection interface device causes the computer to recognize the first and the second storage sections as respectively different logical devices.

3. The external storage device according to claim 2, further comprising:
a changeover switch for changing over control by the access controller,
wherein the access controller
(i) causes the computer to run the antivirus software detection program when the changeover switch has been set to a first setting, and executes the write permission control; and
(ii) does not cause the computer to execute the antivirus software detection program when the changeover switch has been set to a second setting, and permits writing to the second storage section.

4. The external storage device according to claim 3, further comprising:
an encryption process module adapted to execute an encryption process that includes encryption of write data to be written to the second storage section and decryption of read data from the second storage section,
wherein in response to the notification that the presence of antivirus software has been detected, the access controller causes the encryption process module to initiate authentication for the encryption process as a process of the write permission control.

5. The external storage device according to claim 1, further comprising:
a changeover switch for changing over control by the access controller,
wherein the access controller
(i) causes the computer to run the antivirus software detection program when the changeover switch has been set to a first setting, and executes the write permission control; and
(ii) does not cause the computer to execute the antivirus software detection program when the changeover switch has been set to a second setting, and permits writing to the second storage section.

6. The external storage device according to claim 5, further comprising:
an encryption process module adapted to execute an encryption process that includes encryption of write data to be written to the second storage section and decryption of read data from the second storage section,
wherein in response to the notification that the presence of antivirus software has been detected, the access controller causes the encryption process module to initiate authentication for the encryption process as a process of the write permission control.

7. The external storage device according to claim 1, further comprising:
an encryption process module adapted to execute an encryption process that includes encryption of write data to be written to the second storage section and decryption of read data from the second storage section,
wherein in response to the notification that the presence of antivirus software has been detected, the access controller causes the encryption process module to initiate authentication for the encryption process as a process of the write permission control.

8. A method of controlling writing of data to an external storage device connected to a computer, comprising the steps of:
(a) upon connection of the external storage device to a computer, causing the computer to execute an antivirus software detection program that has been stored in the external storage device, to thereby detect presence of antivirus software installed on the computer; and
(b) permitting writing of data from the computer to the external storage device when the antivirus software detection program has detected presence of antivirus software.

9. An external storage device adapted for detachable connection to a computer, comprising:
a connection interface device for connection to the computer;
a first storage section for which only reading of stored data is enabled;
a second storage section for which writing of data is enabled;
an access controller for controlling access to the first and second storage sections by the computer via the connection interface device;
an antivirus software detection program stored in the first storage section and adapted to detect presence of antivirus software installed on the computer; and
an embedded antivirus program stored in the first storage section and adapted to monitor the second storage section for computer virus infections,
wherein, upon connection of the external storage device to a computer, the antivirus software detection program runs automatically and is executed by the computer, and
if the antivirus software detection program has not detected presence of antivirus software on the computer, the embedded antivirus program runs and is executed by the computer.

10. The external storage device according to claim 9, wherein
the connection interface device causes the computer to recognize the first and the second storage sections as respectively different logical devices.

11. The external storage device according to claim 10, further comprising:
an encryption process module adapted to execute an encryption process that includes encryption of write data to be written to the second storage section and decryption of read data from the second memory section.

12. The external storage device according to claim 9, further comprising:
an encryption process module adapted to execute an encryption process that includes encryption of write data to be written to the second storage section and decryption of read data from the second storage section.

13. A method of controlling writing of data to an external storage device connected to a computer, comprising the steps of:
(a) upon connection of the external storage device to a computer, causing the computer to execute an antivirus software detection program that has been stored in the external storage device, to thereby detect presence of antivirus software installed on the computer; and
(b) if the antivirus software detection program has not detected presence of antivirus software, causing the computer to execute an embedded antivirus program that is preliminarily stored in the external storage device and adapted to monitor the external storage device for computer virus infections.
